(19) United States
(12) Patent Application Publication
(10) Pub. No.: US 2017/0129415 A1
(43) Pub. Date: May 11, 2017

(54) IN-VEHICLE BICYCLE ATTACHMENT SYSTEM

(71) Applicant: FORD GLOBAL TECHNOLOGIES, LLC, Dearborn, MI (US)

(72) Inventor: Julio Cesar Maldonado Cruz, Benito Juarez (MX)

(21) Appl. No.: 14/935,945

(22) Filed: Nov. 9, 2015

(51) Int. Cl. B60R 11/00

(52) U.S. Cl. CPC B60R 11/00; B60R 2011/0036; B60R 2011/0075

(57) ABSTRACT

An in-vehicle bicycle attachment system includes a bicycle fork mount disposed in a recess defined in a vehicle rear-most portion of the cargo area. The bicycle fork mount may optionally be configured to rotate about a central axis and/or translate in a vehicle fore and aft direction. The bicycle fork mount may alternatively be configured to pivot between a stowed configuration and a deployed configuration.

### TECHNICAL FIELD

This disclosure relates generally to accessory racks for motor vehicles, and more particularly to an in-vehicle bicycle attachment system for transporting a bicycle in a cargo area of a vehicle.

### BACKGROUND

A variety of exterior bicycle carriers are commercially available, including roof-mounted carriers, rear hatch or trunk-mounted carriers, vacuum-mounted carriers, and hitch-mounted carriers. Each is substantially effective for its intended purpose. However, roof-mounted and hitch-mounted carriers require that the vehicle be originally equipped or retrofitted with features such as roof rails or a hitch box to which the carrier may be attached. Moreover, bicycles attached to roof-mounted carriers may create problems in areas where height restrictions apply, such as tunnels, parking garages, home garages, etc. having a low roof height. Rear hatch or trunk-mounted carriers and vacuum-mounted carriers are typically removed when a bicycle is not being transported, and so risk damage to the vehicle paint and body parts. Therefore, a need is identified for a bicycle carrier for a vehicle that lacks these disadvantages.

To solve these and other problems, the present disclosure relates to an in-vehicle bicycle attachment system. Advantageously, the described system is integrated into and can be hidden within a portion of the vehicle cargo area when not in use.

### SUMMARY

In accordance with the purposes and benefits described herein, in one aspect an in-vehicle bicycle attachment system for a motor vehicle cargo area is described, comprising a bicycle fork mount disposed in a recess defined in a vehicle rear-most portion of the cargo area. In embodiments, the recess is defined in a portion of a load floor of the cargo area. In other embodiments, the recess is defined in or below a portion of a vehicle closure panel scuff plate. A recess-covering door may be provided to conceal the recess when desired.

Optionally, the bicycle fork mount may be configured to rotate about a central axis and/or for translation within the recess in a vehicle fore-aft direction, to allow optimal positioning of a bicycle secured therein. In still other embodiments, the bicycle fork mount may be configured to pivot between a stowed configuration and a deployed configuration.

In another aspect, an in-vehicle bicycle attachment system for a motor vehicle cargo area is described, comprising a bicycle fork mount disposed in a recess defined in a vehicle rear-most portion of a load floor of the cargo area and optionally configured to rotate about a central axis and/or for translation within the recess in a vehicle fore-aft direction.

In still another aspect, a bicycle attachment system for a motor vehicle cargo area is described, comprising a bicycle fork mount disposed in a recess defined in or below a portion of a vehicle closure panel scuff plate. The bicycle fork mount may be configured to pivot between a stowed configuration and a deployed configuration. A retainer may be included for retaining the bicycle fork mount in the stowed configuration. In embodiments, a stop may be included for retaining the bicycle fork mount in a predetermined deployed configuration.

In the following description, there are shown and described embodiments of the disclosed in-vehicle bicycle attachment system. As it should be realized, the system is capable of other, different embodiments and its several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed in-vehicle bicycle attachment system, and together with the description serve to explain certain principles thereof. In the drawing:

FIG. 1 depicts a rear view of a motor vehicle cargo area;

FIG. 2 depicts a side view of an embodiment of the in-vehicle bicycle attachment system of the present disclosure;

FIG. 3A depicts an embodiment of a translatable bicycle fork mount according to the present disclosure;

FIG. 3B depicts an embodiment of a rotatable bicycle fork mount according to the present disclosure;

FIG. 4 depicts an alternative embodiment of the in-vehicle bicycle attachment system of FIG. 2; and

FIG. 5 depicts a top view of a pair of bicycles held in a vehicle cargo area by the described in-vehicle bicycle attachment system.

Reference will now be made in detail to embodiments of the disclosed in-vehicle bicycle attachment system, examples of which are illustrated in the accompanying drawing figures.

### DETAILED DESCRIPTION

Preliminarily, the present disclosure describes an in-vehicle bicycle attachment system used in association with a closed cargo area such as of a sport-utility vehicle (SUV), a cross-over utility vehicle (CUV), a van, and the like. However, the skilled artisan will appreciate that the described system is readily adaptable to any vehicle comprising a cargo area having a load floor, including vehicles such as pickup trucks having open cargo areas.

Also, it is also known to provide a bicycle fork mount for capturing a bicycle fork and retaining the bicycle in a substantially upright position for transport, storage, etc. The basic configuration of a bicycle fork mount is known, and does not merit extensive discussion herein. However, bicycle fork mounts typically include at least a base carrying a central mounting extension configured to support one or two bicycle forks with the bicycle wheel removed. A toggle-type locking bar is included that captures/releases the bicycle forks when actuated by a handle. Any such configuration of bicycle fork mount is contemplated for inclusion herein.

Accordingly, the descriptions and drawings that follow will not be taken as limiting in regard to the above-described features.

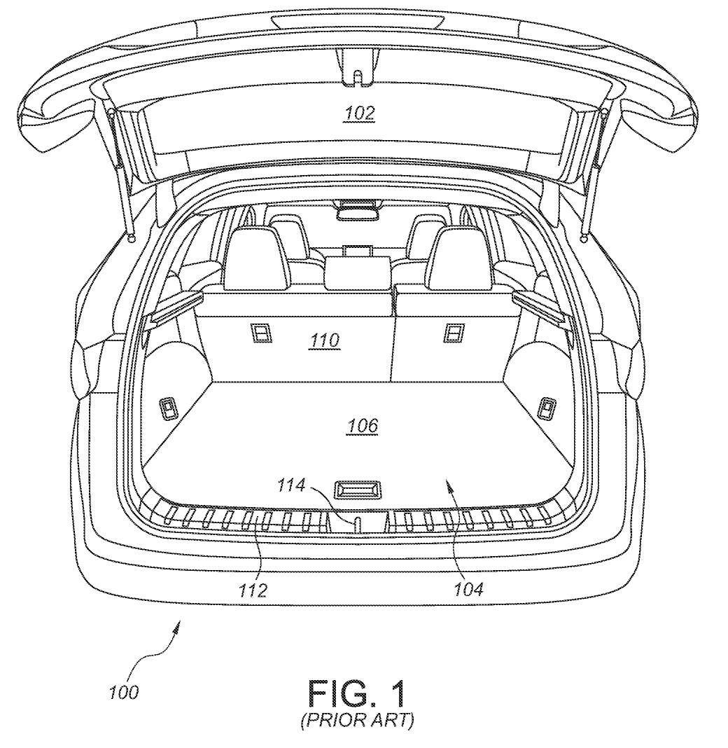

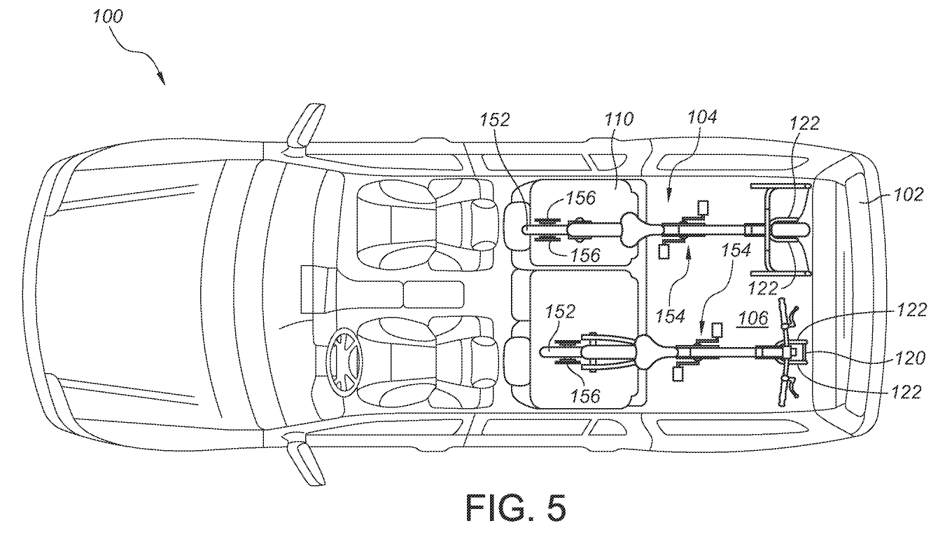

With reference to FIG. 1, there is depicted a rear portion of a vehicle 100 including a hinged closure panel 102 such as a liftgate. A cargo area 104 is defined by at least a load floor 106, opposed side walls 108a, 108b, and a rear-most seatback 110. As is well known, the vehicle seatback 110 may be configured to pivot in a vehicle forward direction (see also FIG. 5), thus increasing the available space in the cargo area 104. As is also known, the vehicle seatback 110 may be a split seatback as depicted, or may be a single seatback. A scuff plate 112 may be disposed at a vehicle rear-most portion of the cargo area 104. As is also well known, the scuff plate 112 is a panel disposed at a threshold of a vehicle closure panel 102 such as a liftgate, a passenger door, etc. which provides protection from potential damage caused by opening/closing the closure panel. A latching/locking mechanism 114 is typically also provided to allow latching/locking the closure panel 102 in a closed configuration.

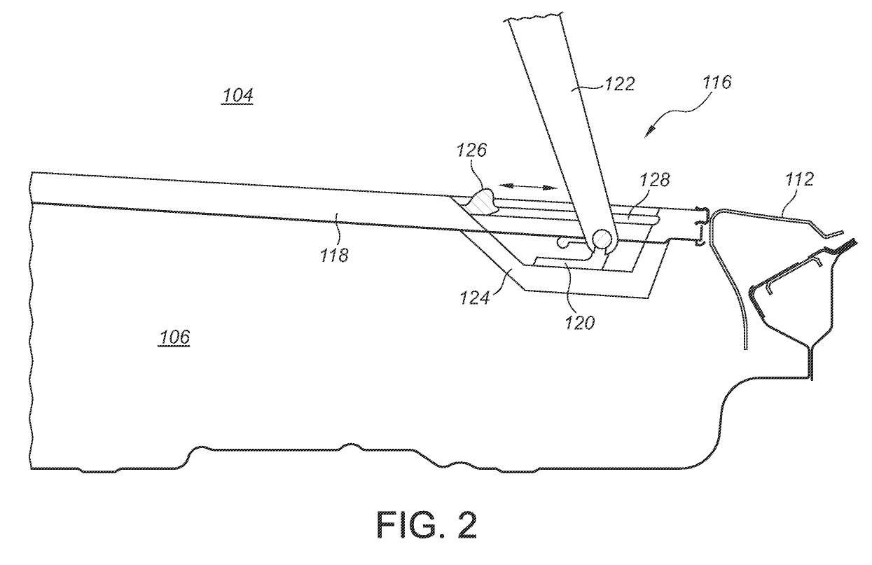

FIG. 2 shows an embodiment of an in-vehicle bicycle mounting system 116 according to the present disclosure. The depicted embodiment is configured for disposing in a vehicle cargo area load floor 106, for example being disposed as shown below a cargo area load floor trim piece 118. The system 116 comprises a bicycle fork mount 120 substantially as described above for capturing and holding one or more bicycle forks 122. In the depicted embodiment, the fork mount 120 is mounted in a recess 124 disposed in the cargo area load floor 106. A door 126 is included for covering and concealing the recess 124 when the system 116 is not in use. In the depicted embodiment, the door 126 is configured for sliding translation between an open and a closed configuration (see arrow) within a rail or groove 128. However, other configurations are contemplated, including without intending any limitation a hinged door 126 (not shown) which pivots between an open and a closed configuration.

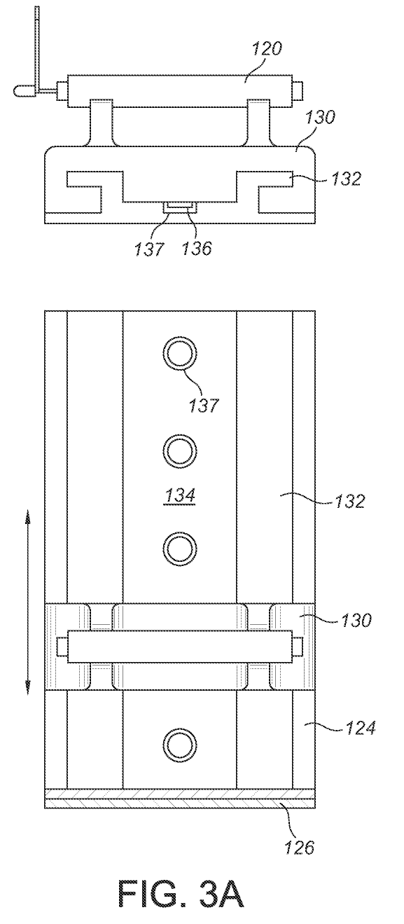

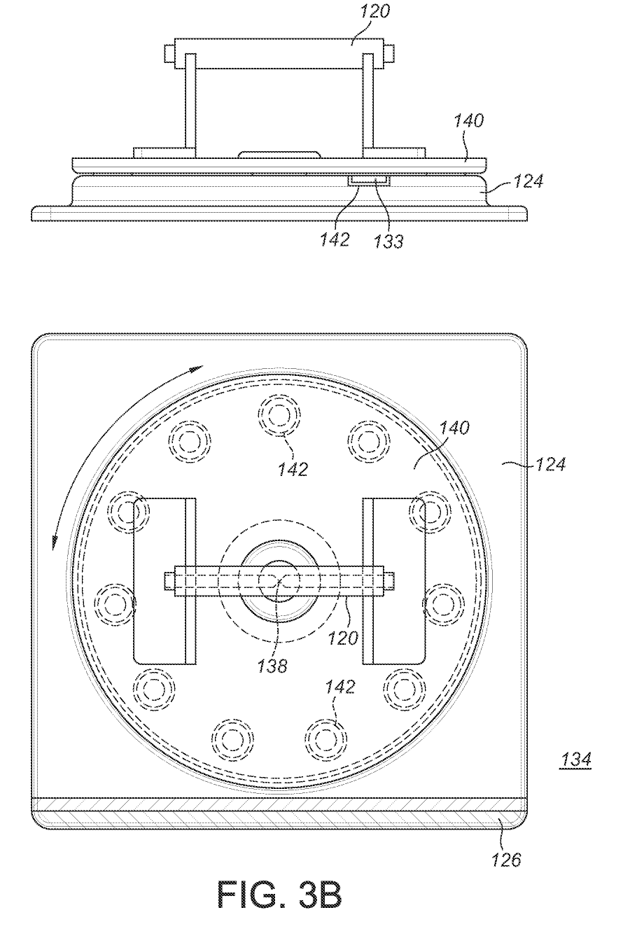

It is also contemplated to provide a bicycle fork mount 120 configured to be adjustable about various axes. As shown in FIG. 3A, in one embodiment the fork mount 120 is configured for sliding translation in a vehicle fore-aft direction (see arrow). As will be appreciated, this feature allows adjustment of the fork mount 120 position to accommodate bicycles of differing size, for example to ensure adequate clearance between the bicycle front fork and handlebars (not shown in this view) and the closed/closing vehicle liftgate (not shown in this view). A number of alternative embodiments for providing this feature are possible and are contemplated. In the depicted embodiment, the fork mount base 130 is configured for slidingly translating along one or more tracks 132 disposed in a floor 134 of the recess 124. One or more spring-loaded pins 136 may be included in association with the base 130, which insert into cooperating spaced apertures 137 defined in the track 132 or the recess 124 to retain the fork mount 120 at a desired position.

Of course, alternative embodiments (not shown) of this retention system are contemplated, including simply providing a series of spaced apertures in the recess floor 134 and cooperating apertures in the fork mount base 130. When the base 130 is in a desired position within the recess 124, the fork mount 120 may be secured in place by any suitable fastener such as a pin, bolt, screw, etc. passed through aligned recess floor and fork mount base apertures.

It is also contemplated to provide a bicycle fork mount 120 configured for rotating about a central axis 138 (see arrow). As shown in FIG. 3B, in one embodiment the fork mount 120 includes or is attached to a rotatable base 140. By rotating the base 140 within the recess 124, the front fork of a captured bicycle (not shown in this view) may be oriented at different angles relative to the bicycle frame (not shown), again to ensure adequate clearance between the bicycle front fork/handlebars (not shown in this view) and a closed or closing vehicle liftgate (not shown in this view).

A number of suitable mechanisms may be provided to accomplish this rotatable movement. For example, the base 140 may include a number of spaced apertures 142 which are alignable with cooperating spaced apertures in the recess floor 134. When the base 140 is rotated to a desired orientation within the recess 124, the fork mount 120 may be secured in place by any suitable fastener such as a pin, bolt, screw, etc. passed through aligned recess floor 134 and fork mount base 140 apertures. Alternatively, a spring-loaded pin 133 may be provided secured to base 140 for accomplishing this task. As yet another alternative, a rotatable bearing (not shown) may be interposed between the base 140 and the recess floor 134 to provide a smooth rotating motion. All such embodiments are contemplated for inclusion herein.

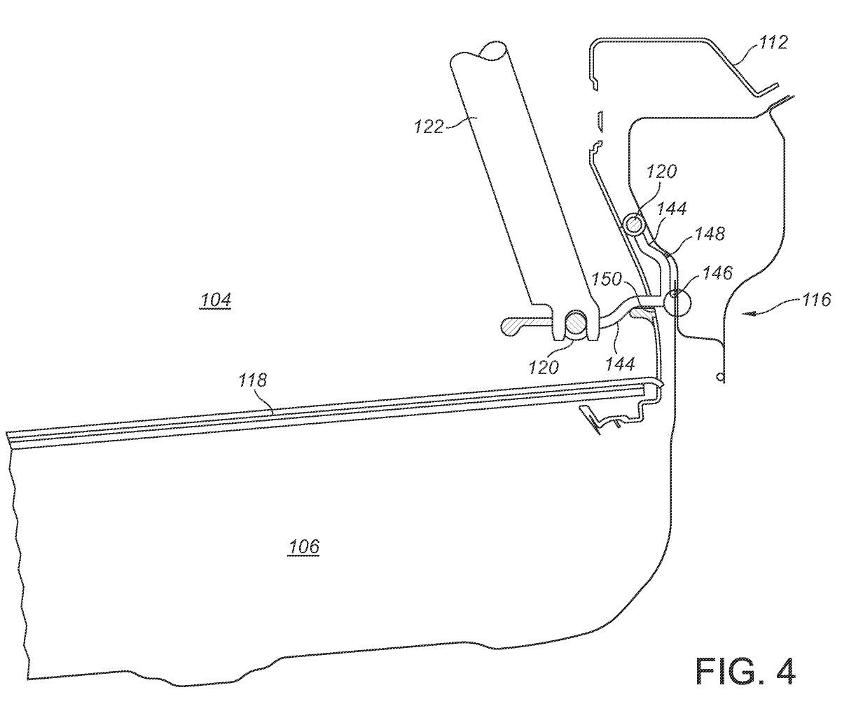

An alternative embodiment of the in-vehicle bicycle attachment system 116 is shown in FIG. 4. The system 116 includes a bicycle fork mount 120 as described above, carried by a neck 144 pivotally mounted to the vehicle 100 such as by a hinge 146. By hinge 146, the fork mount 120 may be pivoted (see arrow) between a stowed configuration such as under scuff plate 112 and a deployed configuration. A retainer 148 may be provided for retaining the fork mount 120 in the stowed configuration. Any suitable retainer 148 is contemplated, including without intending any limitation a friction or interference fit catch configured for capturing or engaging a portion of neck 144, a hook configured for capturing or engaging a portion of neck 144, and others.

In turn, a stop 150 may be provided for preventing fork mount 120/neck 144 from pivoting beyond a desired or predetermined orientation. The stop 150 may be a simple support on which the deployed neck 144 rests as depicted, or alternatively may also include a catch or hook (not shown) for engaging or capturing a portion of neck 144. In still yet another alternative, the stop function may simply be provided by a portion of the scuff plate 112 on which the neck 144 rests when deployed.

In use (see FIG. 5), a user need only remove a wheel 152 of a bicycle 154 to be carried in a vehicle cargo area 104. The forks 122 are secured to the fork mount 120 as described above. Then, the vehicle liftgate 102 may be closed. The bicycle 154 is thus securely stored in the cargo area 104 for transport. As is known, typically a front wheel 152 of a modern bicycle 154 is equipped with a quick release mechanism, and so it may the front wheel of the bicycle that is attached to the fork mount 120 as shown in FIG. 5. However, it is also known in the art to provide bicycles having a rear wheel equipped with a quick-release mechanism, and so the depiction in FIG. 5 should not be taken as limiting.

Of course, additional features may be included. For example, one or more bicycle wheel chocks 156 of known configuration may be included for supporting a bicycle wheel that is not engaged by the described fork mount 120. The chocks 156 may be loose, or may be attached to or integral with a portion of seatback(s) 110. Still more, additional chocks or other holders of known configuration (not shown) may be provided for securing the wheel that was removed prior to attaching the bicycle 154 to the fork mount 120.

Obvious modifications and variations are possible in light of the above teachings. All such modifications and variations are within the scope of the appended claims when interpreted in accordance with the breadth to which they are fairly, legally and equitably entitled.

What is claimed:

1. A bicycle attachment system for a motor vehicle cargo area, comprising a bicycle fork mount disposed in a recess defined in a vehicle rear-most portion of the cargo area.

2. The system of claim 2, including the recess defined in a portion of a load floor of the cargo area.

3. The system of claim 2, including the bicycle fork mount configured to rotate about a central axis.

4. The system of claim 2, including the bicycle fork mount configured for translation within the recess in a vehicle fore and aft direction.

5. The system of claim 1, including the recess defined in or below a portion of a vehicle closure panel scuff plate.

6. The system of claim 5, including the bicycle fork mount configured to pivot between a stowed configuration and a deployed configuration.

7. The system of claim 2, including a recess-covering door configured for translation between an open configuration and a closed configuration.

8. The system of claim 5, including a recess-covering door configured for translation between an open configuration and a closed configuration.

9. A motor vehicle including the system of claim 1.

10. A bicycle attachment system for a motor vehicle cargo area, comprising a bicycle fork mount disposed in a recess defined in a vehicle rear-most portion of a load floor of the cargo area.

11. The system of claim 10, including the bicycle fork mount configured to rotate about a central axis.

12. The system of claim 10, including the bicycle fork mount configured for translation within the recess in a vehicle fore and aft direction.

13. The system of claim 10, including a recess-covering door configured for translation between an open configuration and a closed configuration.

14. A motor vehicle including the system of claim 10.

15. A bicycle attachment system for a motor vehicle cargo area, comprising a bicycle fork mount disposed in a recess defined in or below a portion of a vehicle closure panel scuff plate.

16. The system of claim 15, including the bicycle fork mount configured to pivot between a stowed configuration and a deployed configuration.

17. The system of claim 15, including a recess-covering door configured for translation between an open configuration and a closed configuration.

18. The system of claim 15, including a retainer for retaining the bicycle fork mount in the stowed configuration.

19. The system of claim 15, including a stop for retaining the bicycle fork mount in a predetermined deployed configuration.

20. A motor vehicle including the system of claim 15.
